(19) United States
(12) Patent Application Publication
(10) Pub. No.: US 2022/0266558 A1
(43) Pub. Date: Aug. 25, 2022

(54) METHOD FOR APPLYING SEALING AGENT TO AN INNER SURFACE OF A PNEUMATIC TIRE

(71) Applicant: Nokian Renkaat Oyj, Nokia (FI)

(72) Inventors: Teemu SOINI, Nokia (FI); Esko KUKKONEN, Nokia (FI); Jari OJALA, Nokia (FI); Harri MOISIO, Nokia (FI)

(73) Assignee: Nokian Renkaat Oyj, Nokia (FI)

(21) Appl. No.: 17/670,888

(22) Filed: Feb. 14, 2022

(30) Foreign Application Priority Data
Feb. 23, 2021 (FI) 20215194

(51) Int. Cl. B29D 30/06; B29C 73/16

(52) U.S. Cl. CPC B29D 30/0685; B29C 73/163; B29D 2030/0697; B29D 2030/0694

(57) ABSTRACT

A method is for applying sealing agent to an inner surface of a pneumatic tire. The method includes using a first extrusion device to form at least a part of a first throughput having base elastomer, using a second extrusion device to form at least a part of a second throughput having a curing agent, and mixing the first throughput with the second throughput to form the sealing agent. In addition, a layer of the sealing agent is applied to the inner surface of the pneumatic tire by a dispensing head.

### CROSS-REFERENCE TO RELATED APPLICATIONS

This application claims priority benefit of Serial No. 20215194, filed Feb. 23, 2021 in Finland, and which application is incorporated herein by reference. To the extent appropriate, a claim of priority is made to the above-disclosed application.

### TECHNICAL FIELD

The invention concerns the way in which a pneumatic tire is made self-sealing for a case of puncture happening in use. The invention concerns a method for manufacturing such self-sealing sealant layer to a pneumatic tire.

### BACKGROUND

In pneumatic tires for cars, a puncture caused by a sharp object hitting the tire has been a problem since the beginning of use of pneumatic tires. It is known from various patents that a puncture can be sealed by providing a suitable sealing agent to stick to the object causing the puncture. Thus, when the object is removed from the punctured tire, the sealing agent fills the puncture and prevents the pressurized gas from escaping from the tire. Methods for applying sealing agent are known e.g. from the patent applications EP 0 080 968 and EP 0 161 201. The sealing agent may be applied in a form of a premanufactured strip. Alternatively, as shown in FIG. 1, an extrusion device 300 can be used to extrude sealing agent 200 through a dispensing head 410 onto an inner surface of a pneumatic tire 100. Such a sealing agent may comprise partially crosslinked butyl rubber. A rotator 500 may be used to rotate the tire while applying the sealing agent.

Typically, the material used as sealing agent 200 is sticky and viscous, whereby its application may be problematic. Typically, the sealing agent is heated to at least 70 degrees Celsius to enable application thereof. Heating may e.g. reduce viscosity. However, heating of the sealing agent, in connection with a temperature dependent viscosity, makes an even application of the sealing agent reasonably problematic.

### SUMMARY

It has been found that by using a two-component or multi component sealing agent the problems of prior art can be avoided or reduced. The two components of the sealing agent are a base elastomer and a curing agent. In case of a multi-component sealing agent, some components thereof may constitute the base elastomer and some components may constitute the curing agent. Only when the components, i.e. the base elastomer and the curing agent, are mixed together to form the sealing agent, the vulcanization (i.e. curing) of the sealing agent starts, whereby the sealing agent is workable for some time. The workable time of the sealing agent is referred to as a pot life of the sealing agent. Thus, during the pot life of the sealing agent, the sealing agent may be applied to the pneumatic tire, and it needs not be heated. To ensure application during the pot life and to avoid clogging of the extrusion device, the base elastomer and the curing agent are extruded using separate extrusion devices, and the throughputs of the extrusion devices are mixed to obtain the sealing agent. In contrast, if a pre-mixed composition of the sealing agent would be applied as indicated in FIG. 1, the risk of clogging of the extrusion device would be high, because the sealing agent would be vulcanizing already within the extrusion device.

The invention is described in more detail in independent claim 1. Dependent claims and the description define preferable embodiments.

### BRIEF DESCRIPTION OF THE DRAWINGS

FIG. 1 shows a known system for applying sealing agent onto a surface of a pneumatic tire,

FIG. 2 shows a half of a cross section of a pneumatic tire,

FIG. 3a shows an embodiment of a method for applying sealing agent onto an inner surface of a pneumatic tire,

FIG. 3b shows an embodiment of a method for applying sealing agent onto an inner surface of a pneumatic tire,

FIG. 3c shows an embodiment of a method for applying sealing agent onto an inner surface of a pneumatic tire,

FIG. 4 shows an embodiment of a system and a method for applying sealing agent onto an inner surface of a pneumatic tire,

FIG. 5 shows an embodiment of a system and a method for applying sealing agent onto an inner surface of a pneumatic tire,

FIG. 6 shows an embodiment of a method for applying sealing agent onto an inner surface of a pneumatic tire,

FIG. 7 shows an embodiment of a method for applying sealing agent onto an inner surface of a pneumatic tire,

FIG. 8a shows a layer of sealing agent on an inner surface of a pneumatic tire, the layer having been made from parallel bands of sealing agent,

FIG. 8b shows a layer of sealing agent on an inner surface of a pneumatic tire, the layer having been made from parallel parts of a helical band of sealing agent,

FIG. 9a shows a layer of sealing agent on an inner surface of a pneumatic tire, the layer having been made from parallel bands or parts of a band of sealing agent, the parallel parts being side by side but not overlapping,

FIG. 9b shows a layer of sealing agent on an inner surface of a pneumatic tire, the layer having been made from parallel bands or parts of a band of sealing agent, the parallel parts being side by side and overlapping,

FIG. 10a shows an embodiment, wherein the first throughput of the base elastomer is formed by two extrusion devices, each one extruding a component of the base elastomer, and

FIG. 10b shows an embodiment, wherein the second throughput of the curing agent is formed by two extrusion devices, each one extruding a component of the curing agent.

### DETAILED DESCRIPTION

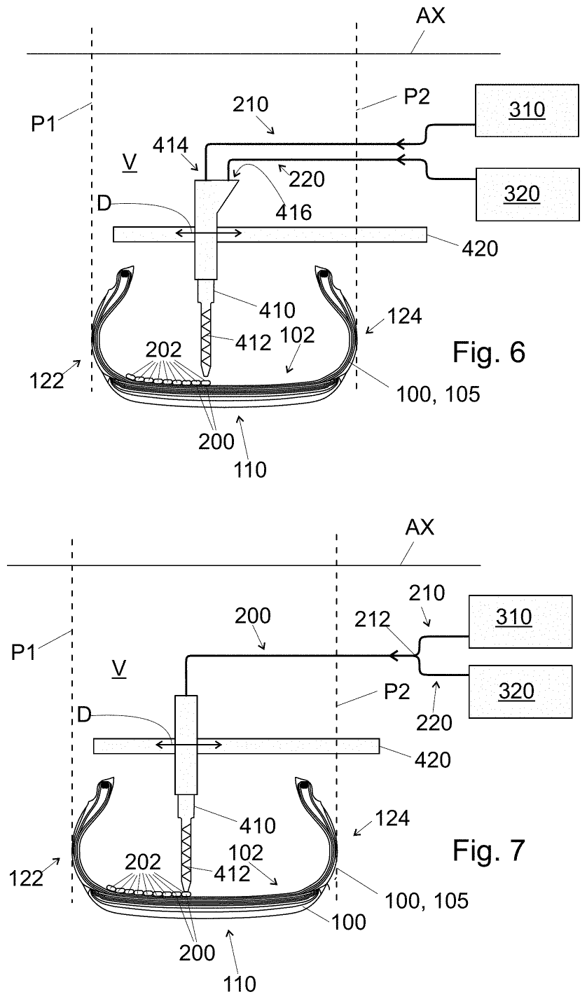

FIG. 2 shows half of a cross section of a pneumatic tire 100. The tire 100 comprises a carcass or body 105 (shown in grey colour adjacent to the innerliner 130). The pneumatic tire comprises a tread 110 that is, in use, configured to contact a surface, such as a road. In use, the tire 100 rotates about an axis AX of rotation, which in FIG. 2 would be horizontal (not shown in FIG. 2), as shown in FIGS. 6 and 7. The tire 100 comprises a first bead portion 141 comprising a first cable 142 and a second bead portion 143 comprising a second cable 144. The carcass 105 extends toroidially from the first bead portion 141 to the second bead portion 143. The carcass 105 typically comprises the cables 142, 144 and the part of the carcass toroidially extending between the cables 142, 144. The carcass of the tire is annular.

The pneumatic tire 100 comprises a first sidewall 122 and a second sidewall 124. Typically, the pneumatic tire 100, e.g. the carcass 105 thereof, comprises an innerliner 130, which is configured to decrease air permeability of the pneumatic tire 100 (i.e. improve its air tightness). For manufacturing reasons, a layer of inside tire paint may be arranged on the innerliner 130. The innerliner 130, optionally with a layer of the inside tire paint, may be arranged as an innermost layer of the pneumatic tire. The pneumatic tire 100 comprises an inner surface 102. At least a part of the inner surface 102 may be formed by the innerliner 130. In case the innerliner 130 is covered with inside tire paint that is not removed, at least a part of the inner surface 102 may be formed by the inside tire paint, as detailed below.

As indicated in background, the inner surface 102 of the pneumatic tire 100 may be provided with sealing agent 200, i.e. self-sealing agent. For clarity, FIG. 2 only shows a part of the inner surface 102 of the tire 100 covered by sealing agent 200. Naturally, the whole inner surface 102 may be covered with the sealing agent 200; or at least the whole area of the inner surface 102 that is opposite to the tread 110 may be covered with the sealing agent 200. A purpose of the sealing agent 200 is that when an object that has punctured the pneumatic tire is removed from the pneumatic tire, the sealing agent 200 fills the puncture and prevents the pressurized gas from escaping the pneumatic tire 100. Preferably, a thickness of a layer of the sealing agent 200 is from 1.5 mm to 5 mm. This applies at least after a setting time i.e. the time after which there is substantially no flowing of the sealing agent 200. This is related to the pot life of the sealing agent, as detailed below. For example, the setting time may equal the pot life. The sealing agent 200 may be applied accordingly. Typically one layer of the sealing agent 200 suffices, but naturally more than one thin layers may be applied on top of each other so as to form a thicker layer having the thickness indicated above.

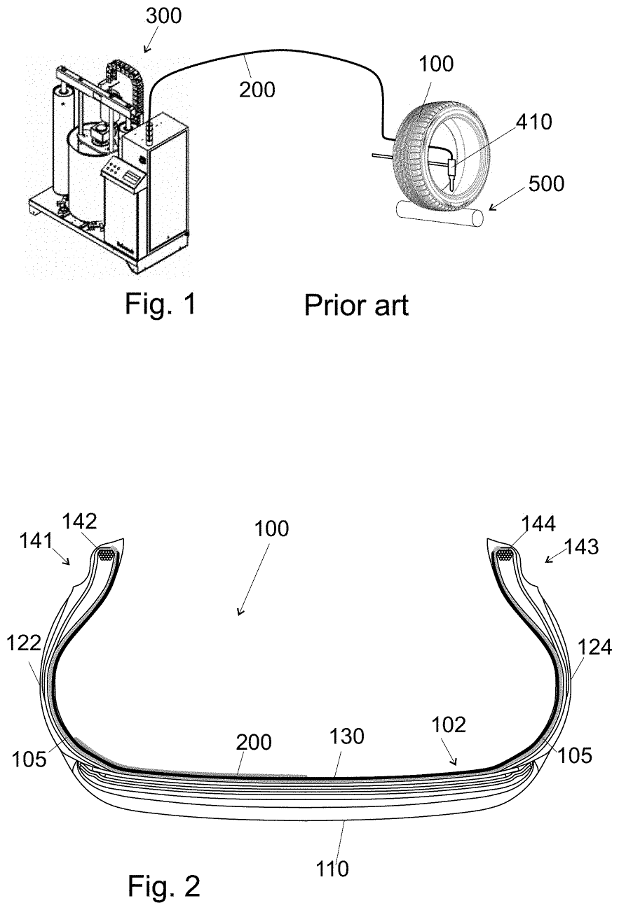

To allow for workability of the sealing agent 200, in the embodiments of the present invention, a two-component sealing agent 200 or a multi component sealing agent 200 is used. The two components are (i) a base elastomer and (ii) a curing agent. As detailed below, the base elastomer may be a mixture of some compounds of a multi component sealing agent. As detailed below, the curing agent may be a mixture of some compounds of a multi component sealing agent. Thus, the sealing agent may comprise also other components. The sealing agent is formed by mixing at least these two components. Neither the base elastomer nor the curing agent alone starts to cross link. However, when mixed together, the curing agent starts and/or accelerates the vulcanization process of the sealing agent, whereby the sealing agent needs to be applied onto the tire reasonably soon after mixing the two components. If the already mixed sealing agent was extruded by only one extruder 300 (as in FIG. 1), the risk of clogging the only extruder 300 and/or the pipeline downstream from the extruder 300 would be high. Cleaning the extruder and/or the pipeline from hardened sealing agent would be hard.

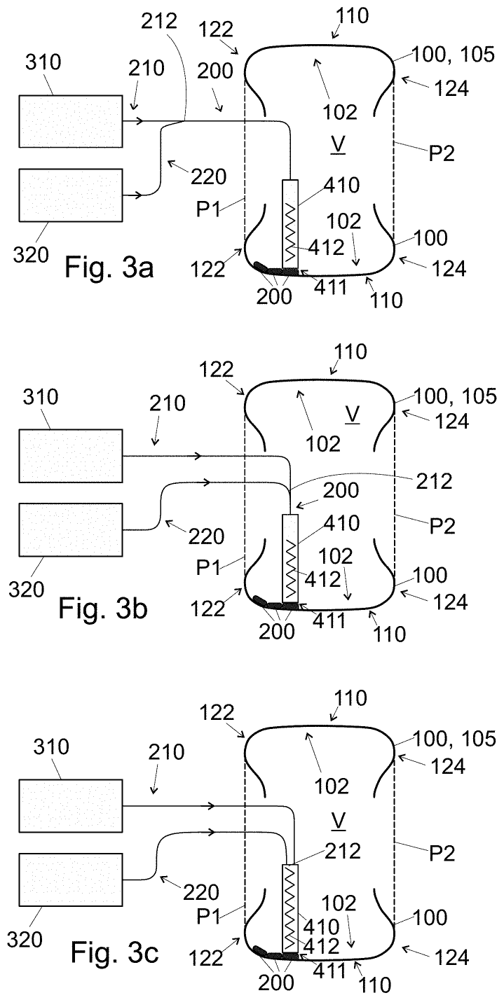

FIGS. 3a to 3c show such embodiments of the present invention, wherein only the base elastomer and the curing agent are extruded. Thus, an embodiment of the method for applying sealing agent 200 to an inner surface 102 of a pneumatic tire 100 comprises using a first extrusion device 310 to form a first throughput 210 comprising base elastomer; and using a second extrusion device 320 to form a second throughput 220 comprising curing agent. Moreover, in a preferred embodiment, the first throughput 210 is free from the curing agent in order to prevent the vulcanization before the first extrusion device 310. Correspondingly, in a preferred embodiment, the second throughput 220 is free from the base elastomer in order to prevent the vulcanization before the second extrusion device 320. However, the base elastomer itself may have been formed by mixing different components and/or the curing agent may have been formed by mixing different components.

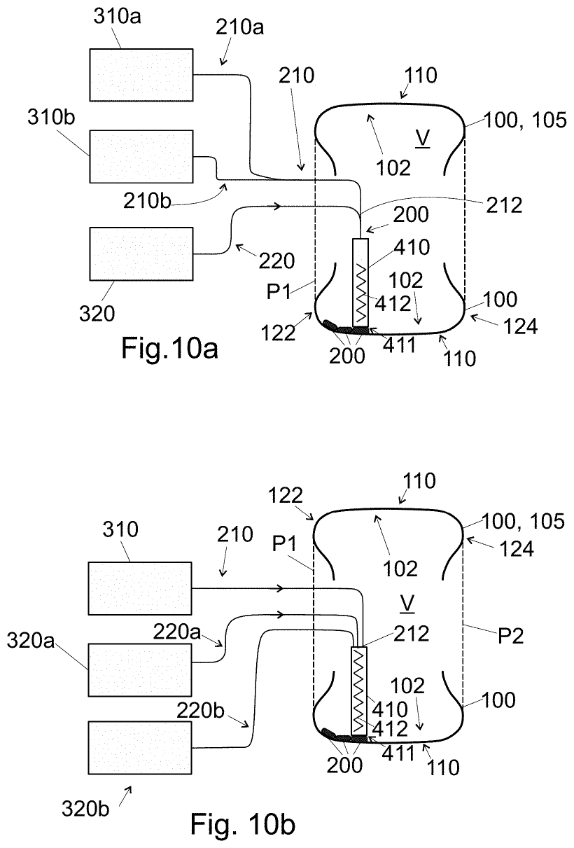

With reference to FIG. 10a, the base elastomer may be formed by mixing a primary first throughput 210a and a secondary first throughput 210b together in order to form the first throughput 210. The primary first throughput 210a may be extruded using a primary first extrusion device 310a. The secondary first throughput 210b may be extruded using a secondary first extrusion device 310b. Thus, an embodiment comprises using a first extrusion device (310a, 310b) to form a part of a first throughput 210 comprising base elastomer. Thus, the “first throughput” refers to the throughput of the base elastomer in total, i.e. all its constituents. This applies in particular below, wherein the mass ratios of the first throughput 210 and the second throughput 220 are discussed.

With reference to FIG. 10b, the curing agent may be formed by mixing a primary second throughput 220a and a secondary second throughput 220b together in order to form the second throughput 220. The primary second throughput 220a may be extruded using a primary second extrusion device 320a. The secondary second throughput 220b may be extruded using a secondary second extrusion device 320b. Thus, an embodiment comprises using a second extrusion device (320a, 320b) to form a part of a second throughput 220 comprising curing agent. The term “second throughput” refers to the throughput of the curing agent in total, i.e. all its constituents. This applies in particular below, wherein the mass ratios of the first throughput 210 and the second throughput 220 are discussed.

Even if not shown, it is possible that (i) the base elastomer and the first throughput 210 thereof are formed by mixing the primary first throughput 210a and the secondary first throughput 210b, and (ii) the curing agent and the second throughput 220 thereof are formed by mixing the primary second throughput 220a and the secondary second throughput 220b.

Referring to FIG. 10b, the parts 220a, 220b of the second throughput can be mixed with each other to form the second throughput at the same location, wherein the first throughput 210 is mixed with these parts 220a, 220b. Even if not shown, the parts 210a, 210b of the first throughput can be mixed with each other to form the first throughput at the same location, wherein the second throughput 220 is mixed with these parts 210a, 210b.

Moreover, it is noted that when all the partial (or full) throughputs are mixed at the same point, it may be immaterial whether a component is considered to form a part of the first throughput 210 or the second throughput 220. For example, referring to FIG. 10b, if the material of the secondary second throughput 220b, if mixed with the material of the first throughput 210, does not cause the mixture to cure, it is irrelevant whether the compound of the secondary second throughput 220b is considered to form a part of the second throughput 220 or the first throughput 210.

Referring to FIGS. 3a to 3c and 10a and 10b, these embodiments comprise mixing the first throughput 210 with the second throughput 220 to form the sealing agent 200 and applying a layer of the sealing agent 200 to the inner surface 102 of the pneumatic tire 100 by means of a dispensing head 410. Referring to FIG. 10a an embodiment comprises mixing parts of the first throughput 210 with the second throughput 220 to form the sealing agent 200 and applying a layer of the sealing agent 200 to the inner surface 102 of the pneumatic tire 100 by means of a dispensing head 410. Referring to FIG. 10b, an embodiment comprises mixing the first throughput 210 with parts of the second throughput 220 to form the sealing agent 200 and applying a layer of the sealing agent 200 to the inner surface 102 of the pneumatic tire 100 by means of a dispensing head 410. Even if not shown, e.g. a primary first throughput 210a (i.e. a part of the first throughput 210) may be first mixed with the second throughput 220, and thereafter, a secondary first throughput 210b (i.e. another part of the first throughput 210) may then be mixed with the mixture to form the sealing agent 200.

As indicated in FIGS. 3a to 3c and 10a, and 10b, the first throughput 210 or the part thereof is mixed with the second throughput 220 or the part thereof to form a third throughput (i.e. the sealing agent 200) and the third throughput is guided through the dispensing head 410 to the inner surface 102 of the pneumatic tire. The first throughput 210 is mixed with the second throughput 220 at a point 212 of mixing. In an embodiment, the first throughput 210 and the second throughput 220 are separately conveyed up to the point 212 of mixing, i.e. they are not mixed before the point 212 of mixing. Even if not shown, other components may be added to the first 210, the second 220, or the third throughput. Moreover, the base elastomer may have been formed of more than one components (e.g. by mixing the parts 210a, 210b); and the curing agent may have been formed of more than one components (e.g. by mixing the parts 220a, 220b). However, as indicated in FIGS. 3a to 3c, an embodiment comprises mixing the first throughput 210 with the second throughput 220 only downstream from the first extrusion device 310 and downstream from the second extrusion device 320. Thus, a point of mixing 212 is downstream from the first extrusion device 310 and downstream from the second extrusion device 320. The term point of mixing 212 refers to such a point, (i) wherein all such compounds of the sealing agent that are needed to start the curing reaction of the sealing agent are mixed together; and (ii) that is most upstream in the direction of flow of these compounds.

The base elastomer as such is configured not to vulcanize (i.e. cure), or vulcanize only very slowly. Thus, a pot life of the base elastomer may be e.g. at least one month at room temperature. The term shelf life can be used instead of the term pot life, because the base elastomer is configured to be stored for a long period without curing. In a similar manner, the curing agent as such is configured not to vulcanize (i.e. cure), or vulcanize only very slowly. Thus, a pot life of the curing agent may be e.g. at least one month at room temperature. The term shelf life can be used instead of the term pot life, because the curing agent is configured to be stored for a long period without curing.

Instead, a pot life of the sealing agent 200 is much shorter than the pot life of either of the base elastomer and the curing agent. This is because the curing agent, when mixed with the base elastomer, is configured to accelerate vulcanization of the sealing agent 200. The pot life of the sealing agent 200 may be e.g. from 5 minutes to 45 minutes at room temperature. Correspondingly, the pot life of the base elastomer may be at least two hundred times the pot life of the sealing agent 200; and the pot life of the curing agent may be at least two hundred times the pot life of the sealing agent 200. A definition for the pot life is the time that it takes, from the mixing, to increase the viscosity of the sealing agent from its initial value by 100%.

In an embodiment, the base elastomer, the curing agent, and the mass flow ratio of the second throughput to the first throughput (hereinafter a mixing ratio) is selected such that a pot life of the sealing agent 200 is from 5 minutes to 45 minutes at room temperature. Typically, a manufacturer of a two-component sealing agent provides, separately, the base elastomer and the curing agent, and also indicates a preferred mixing ratio and the obtainable pot life. A two-component sealing agent for the invention may be arranged available accordingly. By varying the mixing ratio, the pot life can, sometimes, be affected. The mixing ratio may be e.g. at least 1% or at least 5% (by mass, as indicated above). Thus, in an embodiment, a mass flow ratio of the second throughput 220 to the first throughput 210 is at least 1% or at least 5%, such as from 1% to 100%, or from 2% to 50%, or from 5% to 20%.

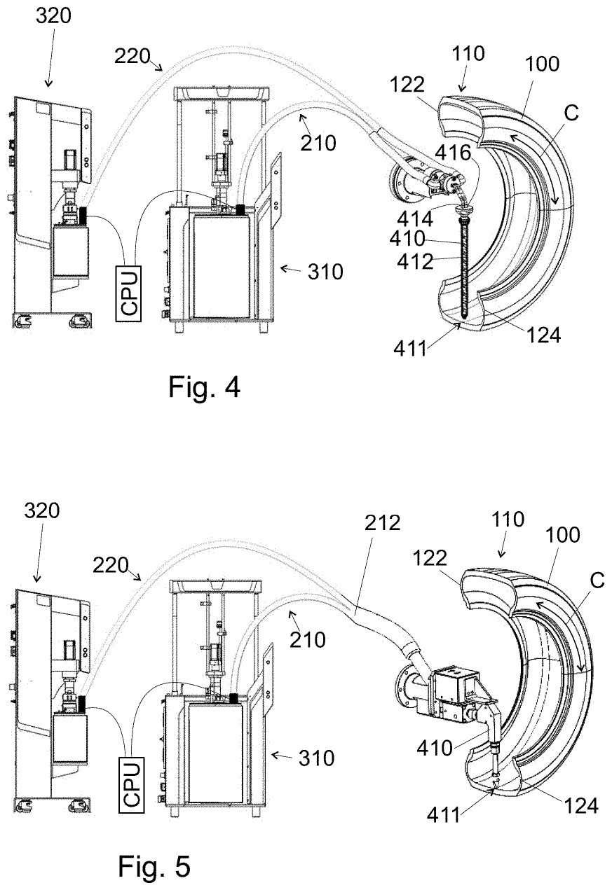

The properties of the sealing agent 200 may depend on the mixing ratio. Thus, for improving quality (i.e. reducing variance in products), the mixing ratio is preferably controlled. Referring to FIGS. 4 and 5 the mixing ratio is preferably controlled by an electronic control unit CPU. However, the mixing ratio may be controlled manually of mechanically. The first and second extrusion devices 310, 320 may be configured function dependently, so that the mixing ratio is substantially constant. Thus, an embodiment comprises controlling a mass flow of the first throughput 210 and/or a mass flow of the second throughput 220 such that a mass flow ratio of the second throughput 220 to the first throughput 210 is constant in time. Evidently, since both the base elastomer and the curing agent are needed, at least at some point of time, neither the mass flow of the first throughput 210 nor the mass flow of the second throughput 220 is zero. Preferably, the mass flow of the first throughput 210 and/or a mass flow of the second throughput 220 is controlled such that a mass flow ratio of the second throughput 220 to the first throughput 210 is constant in time for at least five minutes. As for the term “constant”, a variation range from 80% to 125% of the temporal average may be acceptable without affecting the properties of the sealing agent too much. The mixing ratio may be within the limits discussed above.

The method may comprise measuring at least one of the mass flow of the first throughput 210 and/or the mass flow of the second throughput 220; and controlling at least one of the first extrusion device 310 and the second extrusion device 320 so as to achieve a target mixing ratio by using the measured value(s) of the mass flow(s). Evidently, the target mixing ratio may be within the limit discussed above.

The sealing agent 200, i.e. a mixture comprising at least the base elastomer and the curing agent, is in use of the pneumatic tire 100 configured to stay attached to the inner surface 102 of the pneumatic tire 100 and to seal punctures of the pneumatic tire 100. In an embodiment, the sealing agent 200 is tacky such that the tackiness enables the sealing agent to stay attached to the inner surface of the pneumatic tire 100 in use and enables sealing of punctures of the pneumatic tire 100 in use.

Preferably, a silicone based sealing agent 200 is used. Thus, in an embodiment, the base elastomer comprises silicone based material or silicone. More preferably the base elastomer comprises silicone. An example of such a material is detailed below.

The use of a two-component sealing agent 200 has the further benefit, that the process can be carried out at room temperature. Thus, as opposed to some prior art solutions, no heater for the sealing agent is needed. Therefore, in an embodiment, a temperature of the sealing agent 200 within the dispensing head 410 is from −10° C. to +50° C. The temperature may be e.g. from +10° C. to +40° C. Moreover, the first throughput 210 and the second throughput 220 may also be substantially at room temperature. Thus, in an embodiment, temperatures of the first throughput 210 and the second throughput 220 are, upstream from the point 212 of mixing, from −10° C. to +50° C. The temperatures may be from +10° C. to +40° C. A temperature of the first throughput 210 may be within either of these ranges throughout from the first extrusion device 310 to the point of mixing 212. A temperature of the second throughput 220 may be within either of these ranges throughout from the second extrusion device 320 to the point of mixing 212. A temperature of the sealing agent 200 may be within either of these ranges throughout from the point of mixing 212 to an outlet 411 of the dispensing head 410.

Referring to FIGS. 6 and 7, typically the sealing agent 200 is applied onto the inner surface 102 by rotating the tire 100 about its rotational axis AX and, at the same time, extruding the sealing agent 200 by the dispensing head 410. Thus, an embodiment comprises rotating the pneumatic tire 100 about an axis AX of rotation while applying the layer of the sealing agent 200 to the inner surface 102 of the pneumatic tire 100. The axis AX of rotation is parallel to a direction of a minimum distance between the first sidewall 122 and the second sidewall 124 of the tire 100. In principle, the tire 100 could be fixed and the dispensing head 410 rotatable, but this would typically only complicate the application procedure.

Thus, in an embodiment, before applying the sealing agent 200, the tire 100 has been pre-manufactured, vulcanized and cooled to a storage temperature. Then, the tire 100 is positioned to a tire rotator device 500 such that the rotational axis AX of the tire 100 is more or less horizontal and the tire 100 is rotated around said rotational axis AX. The rotational axis AX may form e.g. an angle of at most 60 degrees with a horizontal direction. The rotational axis AX may be horizontal. The reference numeral 500 is shown in FIG. 1, and a rotator device 500 of prior art can be used in the present invention. The tire rotator device 500 keeps the tire in its place, which may be variable as detailed below, and rotates the tire so that application of the sealing agent 200 can be done substantially downwards to the inner surface 102 of the rotating tire 100. The rotator device 500 may comprise a roll or rolls configured to rotate the tire by contacting with the tread of the tire (see FIG. 1). In the alternative, the rotator device 500 may comprise a wheel-rim shaped connector configured to contact the tire 100 from one of the bead areas 141, 143 (see FIG. 2), and it may be configured to rotate the tire 100 using this connector. Preferably, the direction of flow of the sealing agent 200 within the dispensing head 410 (towards downstream), which may “substantially downwards” as indicated above, forms an angle of from −90 degrees to 90 degrees, preferably from −30 degrees to 30 degrees, with a downward vertical direction.

Preferably, the sealing agent 200 is extruded as an adhesive band 202 or bands 202a, 202b, 202c on to the inner surface 102 by the dispensing head 410. Thus, the dispensing head 410 and/or the tire 100 are moved relative to each other in a direction of the rotational axis AX. The arrow D in FIGS. 6 and 7 indicates this direction. E.g. the dispensing head 410 may be moved along a bar 420, of which longitudinal direction is parallel to the rotational axis AX. The dispensing head 410 may be also in other directions, e.g. in a radial direction and/or it may be turned. In the alternative, the location of dispensing head 410 may be fixed (e.g. relative to ground), and the tire 100 may be moved, relative to the dispensing head, in at least the direction of the rotational axis AX.

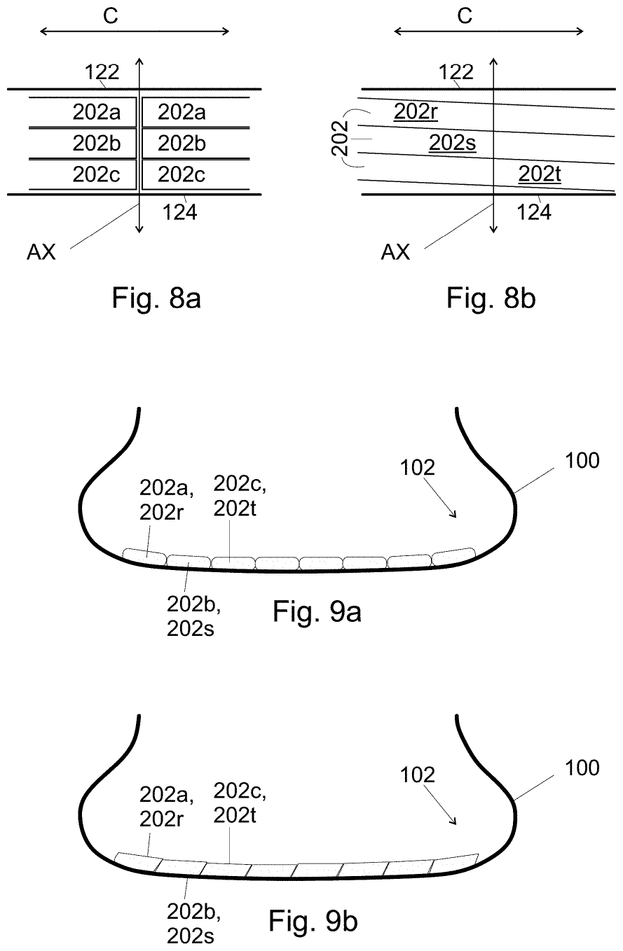

Referring top FIG. 8b, the dispensing head 410 and/or the tire 100 may be moved relative to each other at least in the direction of the rotational axis AX continuously to form a helical band 202 onto the inner surface 102. Parts 202r, 202s, 202t of the helical band 202 are arranged side by side, optionally in an overlapping fashion, to form the layer of the sealing agent 200. For example, the dispensing head 410 and/or the tire 100 may be moved relative to each other in the direction of the rotational axis AX continuously so that the transversal distance (i.e. in the axial direction) that the head/tire move relative to each other during one revolution of the tire, equals a width of the band 202. Typically, the dispensing head 410 is moved, and the location of the tire 100 is kept fixed, though the tire rotates at the location and during application of the sealing agent 200.

Referring top FIG. 8a, the dispensing head 410 and/or the tire 100 may be moved relative to each other at least in the direction of the rotational axis AX stepwise to form circular bands 202a, 202b, 202c that are arranged side by side, optionally in an overlapping fashion, to form the layer of the sealing agent 200. For example, the dispensing head 410 and/or the position of the tire 100 may be kept fixed while applying a band (e.g. 202a) over a full circumference of the tire. Thereafter, the dispensing head 410 and/or the tire 100 may be moved relative to each other in the direction of the rotational axis AX by a distance that corresponds to a width of the band 202a. Typically, the dispensing head 410 is moved, and the location of the tire is kept fixed, though the tire rotates at the location and during application of the sealing agent 200. Thereafter, the dispensing head 410 and/or the position of the tire 100 may be kept fixed while applying a subsequent band (e.g. 202b) over a full circumference of the tire.

Referring to FIG. 9a, the bands 202a, 202b, 202c, or the parts 202r, 202s, 202t of a helical band 202 may be arranged side by side, but these bands or parts of the band need not overlap each other. Referring to FIG. 9b, the bands 202a, 202b, 202c, or the parts 202r, 202s, 202t of a helical band 202 may be arranged side by side, and these bands or pats of the band may overlap with each other. The degree of overlapping can be affected by designing the shape of the outlet 411 of the dispensing head 410 in a corresponding manner. Herein overlapping means the bands or parts of a band being arranged at least partly on top of each other in the radial direction, which in FIGS. 9a and 9b is directed along a longer edge of the paper.

Thus, an embodiment comprises applying the sealing agent 200 to the inner surface 102 of the pneumatic tire 100 in the form of a band 202 or bands 202a, 202b, 202c of which width is less than a half of the width of the pneumatic tire 100. Moreover, the layer of the sealing agent 200 applied on the inner surface 102 of the pneumatic tire 100 comprises the bands 202a, 202b, 202c or parts (202r, 202s, 202t) of the helical band 200 arranged side by side, optionally in an at least partly overlapping fashion.

In order to properly apply the sealing agent 200 onto the inner surface 102 in a reliable manner, preferably, at least an outlet 411 of the dispensing head 410 is arranged inside a space V defined by a carcass 105 of the pneumatic tire 100. Herein the term “space V defined by a carcass 105 of the pneumatic tire 100” refers to such a space that is the smallest convex space encompassing the carcass 105 of the pneumatic tire 100. Moreover, the term “convex space” refers, as conventional, to such a space, wherein any two points within the convex space can be connected by a straight line segment that is encompassed by the convex space. I.e. given any two points of the convex space, the convex space contains the whole line segment that joins the two points. Thus, e.g. cylinder is a convex space, but a hollow cylinder is not. Moreover, e.g. a toroid is not a convex space.

In other words, the space V defined by the carcass 105 is delimited by the tread 110, a first plane P1 that comprises a circular part of the first sidewall 122, and a second plane P2 that comprises a circular part of the second sidewall 124. Moreover, notwithstanding the circular part, the whole first sidewall 122 is arranged on only one side of the first plane P1. Correspondingly, notwithstanding the circular part, the whole second sidewall 124 is arranged on only one side of the second plane P2. Reference is made to FIGS. 3a to 3c.

Referring to FIGS. 3c, 4, 6, and 10b, in an embodiment, the dispensing head 410 comprises a first inlet 414 for receiving the first throughput 210 (or a part thereof) and a second inlet 416 for receiving the second throughput 220 (or a part thereof). Thus, the mixing of the first throughput 210 (or the part thereof) with the second throughput 220 (or the part thereof) only takes place within the dispensing head 410. This ensures that the throughputs 210, 220 (or a parts thereof) are not mixed with each other too early. In such a case, preferably, one of:
the first inlet 414 for receiving the first throughput 210 or a part thereof,
the second inlet 416 for receiving the second throughput 220 or a part thereof, and
both the first inlet 414 for receiving the first throughput or a part thereof and the second inlet 416 for receiving the second throughput 220 or a part thereof is arranged in the space V defined by the carcass 105 of the pneumatic tire 100. This ensures that the first throughput 210 or the part thereof is not mixed with the second throughput 220 or the part thereof upstream from the space V.

However, referring to FIGS. 3a, 3b, 5, and 10a the dispensing head 410 may comprise a single inlet for receiving the sealing agent 200. Therein, the sealing agent 200 has been formed by mixing the throughputs 210, 220 at a point of mixing 212 upstream from the dispensing head 410. Nevertheless, also in such an embodiment, preferably, the first throughput 210 is not mixed with the second throughput 220 upstream from the space V. Reference is made to FIGS. 3b and 10a, which show that the point of mixing 212 is arranged within the space V. Thus, preferably, the point of mixing 212, as defined above, is arranged within the space V.

To ensure sufficient mixing of the first throughput 210 with the second throughput 220, in an embodiment, the dispensing head 410 comprises a mixer 412. Such a mixer 412 is shown e.g. in FIGS. 3a to 3c, 4, 6, 7, 10a and 10b. The mixer 412 may comprise a screw or a pair of screws. Preferably the mixer 412 is a static mixer. In general, a static mixer is a device for the continuous mixing of fluid materials, without moving components. In the art, the term “static mixer” is used interchangeably with terms like “static mixing device” and “motionless mixer”. In general, a static mixer comprises a plate or plates or other twisted elements for guiding the flow of the third throughput, i.e. the sealing agent.

The mixer 412 is configured to mix the material or materials passing through the mixer 412. Thus the mixer 412 is configured to (i) mix the first throughput 210 with the second throughput 220 and/or (ii) mix the sealing agent 200 formed by mixing the first throughput 210 with the second throughput 220. Concerning the latter, referring to FIGS. 3a and 3b, the sealing agent 200 may be formed upstream from the mixer 412. Concerning the former, the mixer 412 may be arranged immediately downstream from the inlets for the throughputs 210, 220, as shown in FIG. 3c.

Preferably, at least a part of the mixer 412 is arranged in the space V. This ensures that the sealing agent 200 is being mixed at least nearly until the outlet 411.

As indicated above, the method is applicable to any two component sealing agent or multi component sealing agent. In general, more than two chemicals may be needed to activate the cross-linking process of the sealing agent. As an example, the sealing agent may comprise three components (hereinafter A, B, and C) so that when all the three components A, B, and C are intermixed, the curing (i.e. cross-linking) reaction starts. Thus a first part of the sealing agent (i.e. base elastomer as discussed above) may comprise one or two of A, B, and C, and the other part of the sealing agent (i.e. curing agent as discussed above) may comprise one or two of A, B, and C, so that, in combination, the base elastomer and the curing agent comprise A, B, and C.

The first component (A) may comprise a curable silyl terminated polymer having at least a hydroxyl functional group per molecule. The second component (B) may be or comprise a cross-linker. If the first component comprises the silyl terminated polymer, the cross-linker may be selected from the group of silanes having at least 2 hydrolysable groups; or in the alternative, the cross-linker may be selected from the group of silyl functional molecules having at least 2 silyl groups. Such cross-linkers are capable of cross-linking with the silyl terminated polymer of the component A. However, without a catalyst, the reaction does not occur, or is at least extremely slow. Thus, a suitable catalyst is also needed. In such a case, the component (C) may be a catalyst selected from the group of titanates and/or zirconates. The function of the component (C) is to increase the speed at which the composition (A and B; and C as the catalyst) cures.

Thus, the silyl of the component (A) is cross-linked by the component (B), i.e. the cross-linker, but only in the presence of the reaction catalyst (C). In a preferable embodiment, the base elastomer comprises the components A and B without C. Correspondingly in the embodiment, the curing agent comprises the constituent C, and may comprise only one of A and B. Thus, even if such a material is inherently a three component material, it may be provided as a two component material. However, all the three components may be provided separately. Applying a three component material is detailed in FIGS. 10a and 10b. Applying a two component material is detailed in FIGS. 3a to 7.

Each one of the constituents A, B, and C may be extruded by its own extrusion device. Reference is made to FIGS. 10a and 10b. In such a case, the curing reaction starts at the point of mixing 212, which is the point wherein all the constituents needed for starting the polymerization reaction have been intermixed; and of several such points the one that is most upstream.

In a preferable embodiment, the base elastomer comprises the components A and B without C; the curing agent comprises the constituent C; and the base elastomer and the curing agent are extruded separately. Reference is made to FIGS. 3a to 3c. Also in this case, the curing reaction starts at the point of mixing 212, which is the point wherein the two base elastomer and the curing agent are intermixed; and of several such points the one that is most upstream.

In addition, the sealing agent 200 may comprise filler material. Filler material may form a part of the base elastomer or a part of the curing agent. In the alternative, filler material may be separately added upstream from the point of mixing 212 to any one of the throughputs 210, 220 or any one of their parts (210a, 210b, 220a, 220b). The filler material may comprise for example reinforcing and/or non-reinforcing inorganic fillers, thermally and/or electrically conductive fillers e.g. metallic fillers and meltable fillers, or a combination thereof.

Both the base elastomer and the curing agent, before mixed together, have a viscosity that permits the materials to be extruded as discussed above. As an example, in an embodiment, a viscosity of the base elastomer (before mixing) may be at least 40 Pa·s as measured by a Brookfield cone plate viscometer RV DIII using the most appropriate cone plate for the viscosity of the composition and using a shear rate of 1/s at room temperature. However, when cured, the sealing agent has such a viscosity that permits the sealing agent to flow into and seal a puncture in a tire. As an example, in an embodiment, a viscosity of the base elastomer (before mixing) is at most 5000 Pa·s as measured as indicated above (shear rate 1/s and at room temperature), and a viscosity of the curing agent (before mixing) is at most 5000 Pa·s as measured as indicated above. These values ensure sufficiently easy flow of the material during extrusion and mixing. Preferably, in terms of rheology, the base elastomer is non-Newtonian and the behavior is pseudoplastic (sometimes called shear thinning). In other terms, its viscosity depends on the shear rate that is used to determine the viscosity in such a way that the viscosity decreases as the shear rate increases. In general this has the effect that the faster the extrusion of the base elastomer, the easier the extrusion thereof. For example, for a shear rate of 0.01/s, the viscosity may be around 30000 Pa·s at room temperature, and at least materials with a viscosity of less than 100000 Pa·s (shear rate 0.01/s and at room temperature) are also usable. Typically the base elastomer forms a major portion of the sealing agent, whereby this applies to the sealing agent, too.

In an embodiment, the pneumatic tire 100 comprises an innerliner 130. A function of the innerliner 130 is to decrease air permeability. It has been found that the innerliner 130 achieves this aim at least when the innerliner comprises butyl rubber, preferably halobutyl rubber. Bromobutyl rubber and chromobutyl rubber are examples of halobutyl rubbers.

For this technical function it is not so important, which one of the layers of the tire is the innerliner. However, most commonly at least a part of the innerliner 130, or an inside tire paint covering the innerliner 130, forms at least a part of the inner surface 102 of the tire 100. When the innerliner 130 or the inside tire paint forms at least a part of the inner surface 102 (e.g. as in FIG. 2), the sealing agent 200 can be optimized so that it adheres well to the material of the innerliner 130 optionally covered with the inside tire paint. Particularly, it has been found that when the innerliner 130 comprises butyl rubber (e.g. halobutyl rubber), the innerliner 130 or the inside tire paint forms a part of the inner surface 102 of the tire 100, the base elastomer comprises silicone or silicone-based material, and the sealing agent is applied on the innerliner 130 or onto a layer of inside tire paint covering the innerliner 130; the adhesion between the sealing agent 200 and the innerliner 130 is good. Thus, even if the silicone or silicone-based material is a good two-component (or multi-component) material also for some other reasons, it furthermore functions well with a butyl-rubber based innerliner 130, optionally covered with inside tire paint, as will be detailed below. In terms of low air permeability, halobutyl rubber is typically better that just butyl rubber.

In case the inner surface 102 (e.g. the innerliner 130 and/or the inside tire paint) has become dirty during storage and/or transportation, the inner surface may be cleaned before applying the sealing agent. Moreover, a conventional one-component sealant typically requires removal of the inside tire paint (if used) before application of the sealant onto the inner surface 102 of the tire. However, it has surprisingly been found that removal of the inside tire paint is not necessary, when a two-component sealing agent 200 comprising silicone is used.

To this end, normally, when a pneumatic tire is manufactured, it is loaded in a curing press to cure the green tire to from the pneumatic tire. Moreover, before the tire is loaded in the curing press, the inside surface of the tire 100, e.g. an inside surface of the innerliner 130, is coated with an inside tire paint. A function of the inside tire paint is to act as a lubricant between the tire innerliner 130 and the curing bladder both during the loading or shaping stage and the stripping stage of the molding operation. Unless adequate lubrication is provided between the bladder and innerliner 130, the bladder tends to stick to the tire. Another function of the inside tire paint is to avoid entrapment of major air bubbles between the tire innerliner and the bladder at the beginning of the shaping operation and to promote entry of air between the bladder and the tire innerliner at the end of the molding operation to avoid adhesion of the tire innerliner to the bladder when the bladder is evacuated prior to withdrawal from within the tire.

An inside tire paint that can be used is a conventional filler-containing, water-based inside tire paint. The inside tire paint may comprise a wax dispersion. The inside tire paint may comprise rubber latex. As a filler material, a mica and/or a silicate may be used. In addition, the inside tire paint may comprise a siloxane or siloxanes, such as polydimethylsiloxane.

In general, micas have the chemical formula X₂Y₄₋₆Z₈O₂₀(OH, F)₄, wherein X is K, Na, or Ca or less commonly Ba, Rb, or Cs; Y is Al, Mg, or Fe or less commonly e.g. Mn, Cr, Ti, or Li; Z is typically Si or Al, but also may include Fe³⁺ or Ti. Silicates on the other hand are anions consisting of silicone and oxygen.

Therefore, after curing the tire, the inner surface 102 of the pneumatic tire 100 may be formed by a layer of inside tire paint applied onto an innerliner 130. Thus, a layer comprising filler material (e.g. silicate and/or mica) and/or wax may form the inner surface 102 of the tire 100, onto which inner surface 102 the sealing agent 200 may be applied as indicated above.

In an embodiment, the tire comprises an innerliner 130 and the inside tire paint is not cleaned before application of the sealing agent 200. In such an embodiment, a layer of inside tire paint arranged onto the innerliner 130 forms at least a part of the inner surface 102 and at least a part of the sealing agent 200 is applied onto the layer of the inside tire paint. In an embodiment, a layer of inside tire paint that comprises silicate and/or mica is arranged on the innerliner 130 and forms at least a part of the inner surface 102; and at least a part of the sealing agent 200 is applied onto the layer of the inside tire paint. More preferably, in such an embodiment the sealing agent 200 comprises silicone. It has been surprisingly found that the silicone based sealing agent 200 adheres well to the mica or silicate of inside tire paint. In this embodiment, the a layer of inside tire paint that comprises silicate and/or mica further comprises siloxane, such as polydimethylsiloxane.

However, as indicated above, the layer of the inside tire paint may be removed before the application of the sealing agent 200 if considered feasible. In an embodiment, the tire comprises an innerliner 130 and the inside tire paint is removed before application of the sealing agent 200. In such an embodiment, the innerliner 130, which is free from the inside tire paint, forms at least a part of the inner surface 102 and at least a part of the sealing agent 200 is applied onto at least a part of the innerliner 130, which is free from the inside tire paint. Preferable materials for the innerliner 130 have been discussed above.

1.-15. (canceled)

16. A method for applying sealing agent to an inner surface of a pneumatic tire, the method comprising:
using a first extrusion device to form a first throughput comprising base elastomer or a part of a first throughput comprising the base elastomer;
using a second extrusion device to form a second throughput comprising a curing agent or a part of a second throughput comprising the curing agent;
mixing the first throughput or the part of the first throughput with the second throughput or the part of the second throughput to form the sealing agent; and
applying a layer of the sealing agent to the inner surface of the pneumatic tire by a dispensing head.

17. The method of claim 16 comprising
mixing the first throughput or the part of the first throughput with the second throughput or the part of the second throughput only downstream from the first extrusion device and downstream from the second extrusion device.

18. The method of claim 16 comprising
rotating the pneumatic tire about an axis of rotation while applying the layer of the sealing agent to the inner surface of the pneumatic tire.

19. The method of claim 16, wherein
the curing agent, when mixed with the base elastomer, is configured to accelerate vulcanization of the sealing agent.

20. The method of claim 16, wherein
a temperature of the sealing agent within the dispensing head is from −10° C. to +50° C.

21. The method of claim 16, wherein
the sealing agent is, in use of the pneumatic tire, configured to stay attached to the inner surface of the pneumatic tire and to seal punctures of the pneumatic tire.

22. The method of claim 16, wherein
a mass flow ratio of the second throughput to the first throughput is from 1% to 50%.

23. The method of claim 16, wherein
at least an outlet of the dispensing head is arranged inside a space defined by a body of the pneumatic tire.

24. The method of claim 16, wherein
the first throughput or the part thereof is not mixed with the second throughput or the part of the second throughput upstream from a space defined by a body of the pneumatic tire.

25. The method of claim 16, wherein
the dispensing head comprises a mixer, wherein the mixer is configured to mix the first throughput with the second throughput; and/or
mix the sealing agent formed by mixing the first throughput with the second throughput.

26. The method of claim 16, wherein
the base elastomer, the curing agent, and the mass flow ratio of the second throughput to the first throughput is selected such that a pot life of the sealing agent is from 5 minutes to 45 minutes.

27. The method of claim 16, wherein
the base elastomer comprises silicone based material or silicone.

28. The method of claim 16, wherein
the pneumatic tire comprises an innerliner and
the innerliner comprises butyl rubber or halobutyl rubber.

29. The method of claim 16, comprising
controlling a mass flow of the first throughput and/or a mass flow of the second throughput such that a mass flow ratio of the second throughput to the first throughput is substantially constant in time.

30. The method of claim 16, comprising
applying the sealing agent to the inner surface of the pneumatic tire in the form of a band or bands of which width is less than a half of a width of the pneumatic tire, whereby
the layer of the sealing agent applied on the inner surface of the pneumatic tire comprises the bands or parts of the band arranged side by side.

31. The method of claim 16, wherein
temperatures of the first throughput or the part of the first throughput and the second throughput or the part of the second throughput are upstream from a point of mixing the throughputs, from −10° C. to +50° C.

32. The method of claim 16, wherein
at least an outlet of the dispensing head is arranged inside a space defined by a body of the pneumatic tire;
the dispensing head comprises a first inlet for receiving the first throughput or the part thereof and a second inlet for receiving the second throughput or the part thereof;
in the space defined by the body of the pneumatic tire there is arranged the first inlet for receiving the first throughput or the part thereof, the second inlet for receiving the second throughput or the part thereof, or both the first inlet for receiving the first throughput or the part thereof and the second inlet for receiving the second throughput or the part thereof.

33. The method of claim 16, wherein
the first throughput or the part thereof is not mixed with the second throughput or the part of the second throughput upstream from a space defined by a body of the pneumatic tire;
a point of mixing is arranged in a space defined by a body of the pneumatic tire; wherein the point of mixing is a point that is most upstream of points where all compounds of the sealing agent that are needed to start the curing reaction of the sealing agent are mixed together.

34. The method of claim 16, wherein
the dispensing head comprises a mixer, wherein the mixer is configured to
mix the first throughput with the second throughput; and/or
mix the sealing agent formed by mixing the first throughput with the second throughput;
at least a part of the mixer is arranged in a space defined by a body of the pneumatic tire.

35. The method of claim 16, wherein
the pneumatic tire comprises an innerliner and
the innerliner comprises butyl rubber;
the innerliner or a layer of inside tire paint arranged on the innerliner forms at least a part of the inner surface and
at least a part of the sealing agent is applied onto at least a part of the innerliner or the layer of the inside tire paint.

36. The method of claim 16, wherein
the pneumatic tire comprises an innerliner and
the innerliner comprises butyl rubber;
a layer of inside tire paint arranged on the innerliner forms at least a part of the inner surface and
at least a part of the sealing agent is applied on the layer of the inside tire paint.

37. The method of claim 16, wherein
the pneumatic tire comprises an innerliner and
the innerliner comprises halobutyl rubber;
a layer of inside tire paint that comprises silicate and/or mica is arranged on the innerliner, the layer of inside tire paint forming at least a part of the inner surface and
at least a part of the sealing agent is applied on the layer of the inside tire paint.

38. The method of claim 16, comprising
applying the sealing agent to the inner surface of the pneumatic tire in the form of a band or bands of which width is less than a half of a width of the pneumatic tire, whereby
the layer of the sealing agent applied on the inner surface of the pneumatic tire comprises the bands or parts of the band arranged side by side in an at least partly overlapping fashion.

39. The method of claim 16, wherein
the curing agent, when mixed with the base elastomer, is configured to accelerate vulcanization of the sealing agent;
the base elastomer comprises a curable polymer and a cross-linker, and
the curing agent comprises a catalyst configured to accelerate a cross-linking reaction of the curable polymer and the cross-linker.
